(19) United States
(12) Patent Application Publication
(10) Pub. No.: US 2013/0198342 A1
(43) Pub. Date: Aug. 1, 2013

(54) MEDIA FORMAT NEGOTIATION MECHANISM DELIVERING CLIENT DEVICE MEDIA CAPABILITIES TO A SERVER

(71) Applicant: General Instrument Corporation, Horsham, PA (US)

(72) Inventors: Haifeng Xu, San Diego, CA (US); Ajay K. Luthra, San Diego, CA (US); Praveen N. Moorthy, San Diego, CA (US)

(73) Assignee: General Instrument Corporation, Horsham, PA (US)

(21) Appl. No.: 13/750,650

(22) Filed: Jan. 25, 2013

Related U.S. Application Data
(60) Provisional application No. 61/591,249, filed on Jan. 26, 2012.

(51) Int. Cl. H04L 29/06

(52) U.S. Cl. CPC H04L 65/60
USPC 709/219

(57) ABSTRACT

A method and apparatus is provided for negotiating a media format to be used by a client device to access a media object. The method includes receiving data over a communications network from a client device. The data specifies at least one media format in which the client device is able to render the media object. Based on the data received from the client device, one or more media formats is determined in which the media object is available so that the media object is renderable by the client device. The media object is delivered to the client device over the communications network in at least one of the one or more media formats.

### BACKGROUND

Media designed for distribution over the Internet by servers come in many forms and formats. Media players residing on client devices interpret incoming media objects and convert the media into human-perceivable form, i.e., into audio and video form for outputting to a user.

Media players residing on client device may have individual capabilities and support a set of media formats, while media servers may offer media content in a number of different media formats. Conventionally, media servers specify to the media player the different media formats in which media content is available. The user then selects the proper media format(s) that is to be used by the media player on the client device. For example, an iOS media player may support the QuickTime media format while a Windows media player may support WMV media formats. Furthermore, different iOS devices may support different media formats i.e., iPhone supports MPEG-4 AVC baseline profile while iPad supports MPEG-4 AVC main profile. Accordingly, to allow the client device to play the media content, the user needs to understand the media formats and capabilities supported by client devices and then select the appropriate format for the device.

### SUMMARY

In accordance with the present invention, a method and apparatus is provided for negotiating a media format to be used by a client device to access a media object. The method includes receiving data over a communications network from a client device. The data specifies at least one media format in which the client device is able to render the media object. Based on the data received from the client device, one or more media formats is determined in which the media object is available so that the media object is renderable by the client device. The media object is delivered to the client device over the communications network in at least one of the one or more media formats.

In accordance to another aspect of the invention, a client device is provided which includes a network interface for communicating over a communications network and at least one media player for rendering media objects received by the network interface over the communications network. The client device also includes at least one output device for presenting the media object rendered by the media player. A processor is provided which is configured to send one or more parameters reflecting a media format that is supported by the media player to a media content source over the communications network.

### BRIEF DESCRIPTION OF THE DRAWINGS

FIG. 1 shows an illustrative operating environment that includes a communications network.

FIG. 2 is a block diagram of one example of a client device which illustrates additional features of the media player shown in FIG. 1.

FIG. 3 shows one illustrative example of a message exchange process used to negotiate a media format between a client device and server.

FIG. 4 shows one example of an architecture that may be employed by the client device shown in FIGS. 1 and 2.

### DETAILED DESCRIPTION

To address the aforementioned problems and limitations, a client device receiving a media object and a server delivering the media object undergo a negotiation process to determine the media format in which the media object should be delivered to the client device. As detailed below, as part of the negotiation process the client device informs the server of the media formats it supports. In addition, the client device may inform the server of its media related capabilities i.e., native screen size, network preference, buffer size, and CPU load. The server in turn responds by selecting the proper representation for the media content, which may or may not require the server to perform transcoding and media format conversion. and before delivering the media object to the client. In this way media management on the part of the user can be simplified.

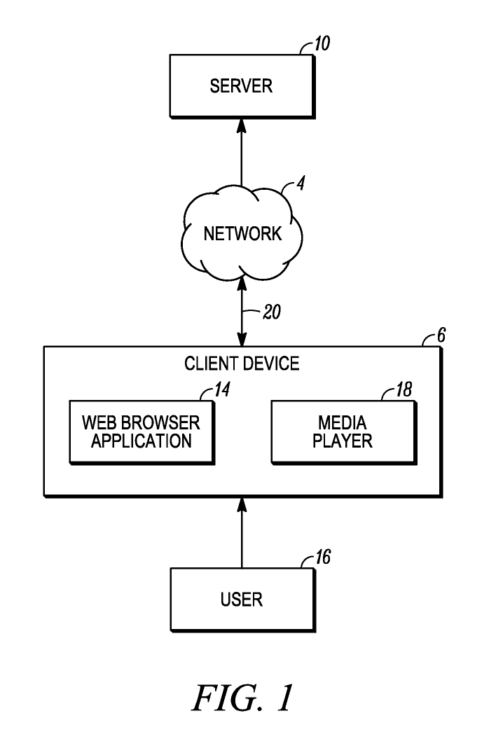

FIG. 1 shows an illustrative operating environment that includes a communications network 4. Network 4 may be a wide-area network such as the Internet, a local-area network (LAN), an enterprise network, or one or more other types of networks. Furthermore, network 4 may include wired and/or wireless links.

Multiple devices may communicate over network 4. As illustrated in the example of FIG. 1, a network connection 20 connects client device 6 to network 4. Client device 6 may be any of a variety of different types of network-enabled devices. For example, client device 6 may be a personal computer, smartphone, tablet, gaming platform, laptop computer, personal digital assistant, handheld computer, mainframe computer, personal media player, network television, network workstation, server, a device integrated into vehicles, a television set top box, or other type of network device.

In some examples the client device 6 is a mobile communications device such as a wireless telephone that also contains other functions, such as PDA and/or music player functions. To that end the device may support any of a variety of applications, such as a telephone application, a video conferencing application, an e-mail application, an instant messaging application, a blogging application, a digital camera application, a digital video camera application, a web browsing application, a digital music player application, and/or a digital video player application.

Furthermore, media content source 10 may communicate with client device 6 over network 4. In the example of FIG. 1 the media content source is a download server 10. Server 10 may be any of several different types of network devices. For instance, server 10 may be a conventional web server, specialized media servers, personal computers operating in a peer-to-peer fashion, or other types of network devices.

In the example of FIG. 1, a browser application 14 executes on client device 6. In one particular example the browser application 14 is a web browser application. Of course, in some implementations the browser application 14 may operate in accordance with a suite of protocols and standards other than those employed by the World Wide Web. Moreover, instead of a web browser, in some embodiments any appropriate graphical user interface may be employed which allows the user to select media content from the media content source. For purposes of illustration, however, the following discussion will assume that a web browser application is being employed.

A user 16 of client device 6 may request that web browser application 14 present a web page provided by server 10. In response to the request from user 16, web browser application 14 may cause client device 6 to send a request to server 10 via network 4. The request may be a Hypertext Transfer Protocol (“HTTP”) request, a HTTP with Secure Sockets Layer (“HTTPS”) request, or a request that employs another network protocol. In response to the request from web browser application 14, server 10 may send to web browser application 14 a response that includes the requested web page. Upon receiving the web page, web browser application 14 may cause client device 6 to render the web page.

The web page may include a media object that is to be presented as part of the web page. For example, the web page may identify the media object using one or more Hypertext Markup Language (“HTML”) tags. The media object may be audio data (e.g., a song, sound effect, musical composition, etc.), audio/video data (e.g., a movie, clip, animation, etc.), or other types of media. As illustrated in the example of FIG. 1, client device 6 may include a media player 18 that is capable of causing client device 6 to render the identified media object.

Each media object is a data structure that has a particular media format. Media objects may be made available in a variety of different media formats. The format of a media file is often evidenced by its file extension, which is the two or three-character code in the portion of the filename preceded by a dot (.) that indicates the type of file, such as the format in which the file was created. The file extensions for some examples of common media formats are shown in Table. 1. A media player can generally access the content of a limited number of media objects. Examples of media players include RealPlayer, Macromedia Shockwave Player, Windows Media Player, and MusicMatch Jukebox Plus. To access the content of a media object in a particular media format, the media player employs a compressor/decompressor standard commonly called a “codec.” Table 1 also lists some examples of common media formats for audio, video and multimedia and indicates the media format it is able to access.

TABLE 1

| Media Format | Description | Compatible Codec |
|---|---|---|
| .mp3 | Audio | Audio player |
| .mov | Audio & Video | Quicktime player |
| .swf | Audio & Video | Flash player |
| .tif(f) | Image | Image viewer |
| .mid | Audio | Midi player |
| .mpg | Audio and Video | Mpeg player |
| .snd | Audio | Audio player |
| .bmp | Picture (Bitmap) | Picture Viewer |
| .wav | Audio | Audio player |

Common codecs for Video includes MPEG-2, AVC/h.264, WMV, MPEG-4 ASP. Each codec supported by media player may associate a set of profiles and levels. For example, iPhone may support Baseline Profile with Level 3 while iPad may support Main Profile with Level 4. Common codecs for Audio includes AC3, AAC, and MP3.

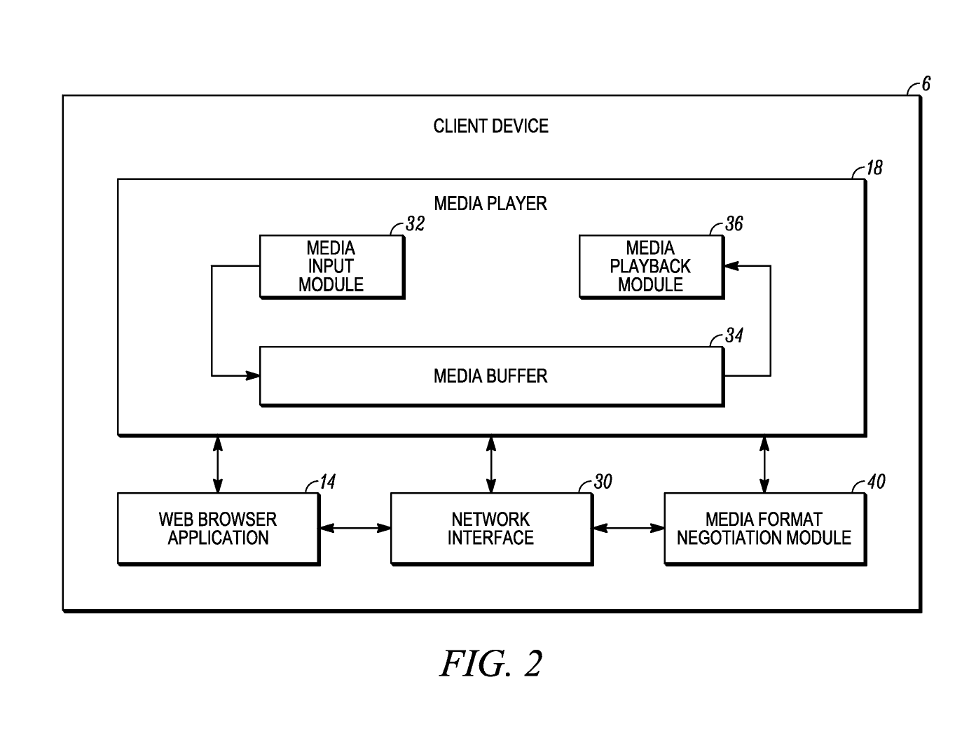

In order to cause client device 6 to render the media object, media player 18 may cause client device 6 to output to server 10 a request for media data units of the media object. A media data unit (“MDU”) may be one or more video frames, a set of audio samples, or a unit of another type of media data. In response to this request, server 10 may send MDUs of the requested media object to client device 6. Server 10 may send MDUs of the requested media object to client device 6 in a variety of ways. For example, server 10 may use a media streaming protocol to send MDUs of the requested media object to client device 6. These media streaming protocols may include, by way of example, HTTP Live Streaming, Smooth Streaming, the Real-Time Streaming Protocol (“RTSP”), Real-Time Transport Protocol (“RTP”), Real-time Transport Control Protocol (“RTCP”), Real-Time Messaging Protocol (“RTMP”), Advanced Systems Format (“ASF”), Real Data Transport (“RDT”), Motion Pictures Experts Group (“MPEG)-2 transport stream, and other protocols. In another example, server 10 may send MDUs of the requested media object to client device 6 as a progressive download via HTTP or another network protocol. During a progressive download, all of the MDUs in the requested media object may be stored to a hard disk of client device 6, but playback of the MDUs may begin before all of the MDUs in the requested media object have been stored to the hard disk of client device 6. Of course, in other implementations transmission techniques such live streaming and video-on-demand may be employed as an alternative to progressive downloading, in which case details of the media player 18 shown in FIG. 2 will vary as appropriate to accommodate whatever transmission technique is employed.

After client device 6 begins to receive the media object, media player 18 may cause client device 6 to begin rendering the media object. Media player 18 may begin rendering the media object within a window embedded within the web page, within a media player window that is separate from the web page, within a full-screen window, or in another type of window.

FIG. 2 is a block diagram of one example of a client device 6 which illustrates additional features of media player 18. In the example of FIG. 2, client device 6 includes a network interface 30. Network interface 30 may be a variety of different types of network interfaces. For instance, network interface 30 may be an Ethernet card, a virtual local area network (“VLAN”) interface, a token ring network interface, a fiber optic network interface, a wireless network interface (e.g., Bluetooth, Wi-Fi, WiMax, Wireless Broadband, etc.), or another type of network interface. Web browser application 14 (or, alternatively, as mentioned above, a suitable graphical user interface) and media player 18 may use network interface 30 to send information on network 4 and to receive information from network 4.

User 16 may interact with web browser application 14 to request that web browser application 14 present a web page. When web browser application 14 receives a request from user 16 to present a web page hosted by web server 10, web browser application 14 may cause network interface 30 to send one or more messages to web server 10. The messages sent by network interface 30 include a request to retrieve the web page. Subsequently, network interface 30 may receive one or more messages that include the web page. When network interface 30 receives the messages that include the web page, web browser application 14 may begin to render the web page. While rendering the web page, web browser application 14 may determine that the web page includes an embedded media object. When web browser application 14 determines that the web page includes an embedded media object, web browser application 14 may cause media player 18 to start executing on client device 6.

When media player 18 starts executing on client device 6, a media input module 32 in media player 18 may cause network interface 30 to send one or more media request messages to web server 10. The media request messages instruct web server 10 to start sending a stream of MDUs to client device 6. In response to these media request messages, web server 10 may start to send a stream of MDUs to client device 6. When network interface 30 receives MDUs in the stream of MDUs, media input module 32 may temporarily store the MDUs in a media buffer 34.

In the example of FIG. 2, media player 18 includes a media playback module 36. Media playback module 36 removes MDUs from media buffer 34 and, using the appropriate codec available to it, causes client device 6 to present media data indicated by the removed MDUs. For example, media playback module 36 may remove from media buffer 34 a MDU that indicates a set of audio samples. In this example, media playback module 36 may then cause client device 6 to output audible sounds represented by the set of audio samples.

Server 10 typically makes media objects available in a limited number (.e.g., one or two) of media formats and allows the client to select the format that is compatible with the media player or players available to it.

Instead of simply having the server 10 present all of its available media formats to the client and allowing the client device to choose among them, in the present case the client device provides details of its media capabilities to the server. Based on these capabilities the server provides the client device with a list of media format options that is best suited for it. If there is more than one option, the client device can then select the most suitable option.

As shown in FIG. 2, the client device 6 includes a media format negotiation module 40 that stores all media related information about the client device and communicates this information to the server. That is, the media format negotiation module 40 communicates to the server the media format or formats supported by the client device 6, as well as possibly other media related capabilities of the client device (discussed below). The media format negotiation module 40 also selects the media format to be used in those cases where the server offers to deliver the media object in multiple media formats. In operation, the media format negotiation module 40 causes network interface 30 to send messages to server 10. Likewise, media format negotiation module 40 receives messages from the server 10 via the network interface 30. Although media format negotiation module 40 is shown in FIG. 2 as being an independent component, in some implementations it may be incorporated into another module, component or application. For instance, in some cases the media format negotiation module 40 may be incorporated into web browser application 14, possibly as a plug-in module. In other cases the media format negotiation module 40 may be incorporated into the media player 18 or even the operating system employed by the client device 6.

The media capabilities that are provided by the client device 6 to the server 10 by the media format negotiation module 40 will typically include the codecs available to it and any other information needed by the client device to render the media object. These capabilities may include, by way of example, parameters such as mime type, sampling rate, language capabilities, bandwidth capabilities and so. In addition, physical device-specific parameters and attributes characterizing the client device may also be included in the media capabilities provided to the server 10. Such parameters may include, for instance, parameters describing the device display such as screen height and width and native resolution, client memory size, video buffer size, processing capabilities (i.e. number of processor cores, hardware A/V accelerator), A/V coding tools (i.e. ability to support CABAC, B pictures etc.), audio channel parameters and so on. Even if not required to render the media object, these additional parameters may allow the presentation of the media object to be better optimized.

The media capabilities may be provided in a device description document that is delivered by the media format negotiation module 40 to the server over the communications network *. The device description document may employ any format that allows the server to parse the information that it needs to select one or more media formats for the client device. In some implementations the device description document may be employ a format that presents the capability information as structured data, which is data that is organized in accordance with a schema. Examples of suitable device description formats that can present the media capability information as structured data include Extensible Markup Language (XML), JavaScript Object Notation (JSON), Ordered Graph Data Language (OGDL) and Comma-Separated Values (CSV). Of course, the information in the device description document may be presented in accordance with other formats and schemas, including those which do not employ structured data formats.

Table 2 shows an illustrative schema of a device description document that is formatted in accordance with XML. Likewise, Table 3 shows an example of a device description document for a particular client device which uses the schema of Table 2.

```
TABLE 2
<?xml version=“1.0” encoding=“ISO-8859-1” ?>
<xs:schema xmlns:xs=“http://www.w3.org/2001/XMLSchema”>
<xs:element name=“ClientMediaCaps”>
<xs:complexType>
      <xs:sequence>
      <xs:element name=“DeviceType”>
      <xs:complexType>
      <xs:sequence>
      <xs:element name=“deviceName” type=“xs:string”/>
      <xs:element name=“mediaPlayer” type=“xs:string”/>
      <xs:element name=“screenWidth” type=“xs:positiveInteger”/>
            <xs:element name=“screenHeight”
            type=“xs:positiveInteger”/>
      <xs:element name=“audioChannels” type=“xs:positiveInteger”/>
      </xs:sequence>
      </xs:complexType>
      <xs:element name=“MediaType”>
      <xs:element name=“mimeType” type=“xs:string”/>
      </xs:element>
      <xs:element name=“VideoType”>
      <xs:complexType>
      <xs:sequence>
      <xs:element name=“mimeType” type=“xs:string”/>
      <xs:element name=“codecs” type=“xs:string”/>
      <xs:element name=“frameType” type=“xs:string”/>
      <xs:element name=“width” type=“xs:positiveInteger”/>
            <xs:element name=“height” type=“xs:positiveInteger”/>
      <xs:element name=“bandwidth” type=“xs:positiveInteger”/>
      </xs:sequence>
      </xs:complexType>
      </xs:element>
      <xs:element name=“AudioType”>
      <xs:complexType>
      <xs:sequence>
      <xs:element name=“mimeType” type=“xs:string”/>
      <xs:element name=“codecs” type=“xs:string”/>
      <xs:element name=“lang” type=“xs:string”/>
      <xs:element name=“samplingRate” type=“xs:positiveInteger”/>
      <xs:element name=“bandwidth” type=“xs:positiveInteger”/>
      </xs:sequence>
      </xs:complexType>
      </xs:element>
      </xs:sequence>
</xs:complexType>
</xs:element>
</xs:schema>
```

```
TABLE 3
<ClientMediaCaps>
      <DeviceType>
            <deviceName>Motorola Smartphone</deviceName>
            <mediaPlayer>Ice Cream Sandwich Player</mediaPlayer>
            <screenWidth>640</screenWidth>
            <screenHeight>480</screenHeight>
            <audioChannels>2</audioChannels>
      </DeviceType>
      <MediaType>
            <mimeType>video/MP2T</mimeType>
      </MediaType>
      <MediaType>
            <mimeType>application/x-mpegURL</mimeType>
      </MediaType>
      <VideoType>
            <mimeType>video/mp4</mimeType>
            <codecs>avc1.4D401F</codecs>
            <frameRate>30000/1001</frameRate>
            <bandwidth>3000000</bandwidth>
            <width>1280</width>
            <height>720</height>
      </VideoType>
      <AudioType>
            <mimeType>audio/mp4</mimeType>
            <codecs>mp4a.40.2</codecs>
            <lang>English</lang>
            <bandwidth>512000</bandwidth>
            <samplingRate>48000</samplingRate>
      </AudioType>
</ClientMediaCaps>
```

After receiving the device description document and determining the most suitable media format or formats in which it can provide the requested media object or objects to the client device, the server can respond to the client device with a media format description document which specifies the media format or formats it has selected as being most compatible with the capabilities of the client device. Table 4 shows an illustrative schema of a media format description document that is formatted in accordance with XML. Likewise, Table 5 shows an example of a media format description document for a particular server/client device pair which uses the schema of Table 4.

```
TABLE 4
<?xml version=“1.0” encoding=“ISO-8859-1” ?>
<xs:schema xmlns:xs=“http://www.w3.org/2001/XMLSchema”>
<xs:element name=“ServerMediaOption”>
<xs:complexType>
      <xs:sequence>
      <xs:element name=“MediaType”>
      <xs:element name=“mimeType” type=“xs:string”/>
      </xs:element>
      <xs:element name=“VideoType”>
      <xs:complexType>
      <xs:sequence>
      <xs:element name=“mimeType” type=“xs:string”/>
      <xs:element name=“codecs” type=“xs:string”/>
      <xs:element name=“frameType” type=“xs:string”/>
      <xs:element name=“width” type=“xs:positiveInteger”/>
            <xs:element name=“height” type=“xs:positiveInteger”/>
      <xs:element name=“bandwidth” type=“xs:positiveInteger”/>
      </xs:sequence>
      </xs:complexType>
      </xs:element>
      <xs:element name=“AudioType”>
      <xs:complexType>
      <xs:sequence>
      <xs:element name=“mimeType” type=“xs:string”/>
      <xs:element name=“codecs” type=“xs:string”/>
      <xs:element name=“lang” type=“xs:string”/>
      <xs:element name=“samplingRate” type=“xs:positiveInteger”/>
      <xs:element name=“bandwidth” type=“xs:positiveInteger”/>
      </xs:sequence>
      </xs:complexType>
      </xs:element>
      </xs:sequence>
</xs:complexType>
</xs:element>
</xs:schema>
```

TABLE 5

```
<ServerMediaOption>
      <MediaType>
            <mimeType>application/x-mpegURL</mimeType>
      </MediaType>
      <VideoType>
            <mimeType>video/mp4</mimeType>
            <codecs>avc1.4D401F</codecs>
            <frameRate>30000/1001</frameRate>
            <bandwidth>1000000</bandwidth>
            <width>640</width>
            <height>480</height>
      </VideoType>
      <AudioType>
            <mimeType>audio/mp4</mimeType>
            <codecs>mp4a.40.2</codecs>
            <lang>English</lang>
            <bandwidth>128000</bandwidth>
            <samplingRate>48000</samplingRate>
      </AudioType>
</ServerMediaOption>
```

By informing the server of the client device's capabilities, the server will be better able to optimize the delivery of the media object to the client device. For example, if the client device has a native resolution of 640×480, even although its media player supports a resolution of 720p, the server may deliver a video object at a resolution of 640×480 in order to best utilize the capabilities of the client device while saving network bandwidth.

If the client device is presented with multiple media format options from which to choose, the selection may be performed in any of a variety of different ways. In one example, the user may provision the client device with one or more client profiles which specify a preferred media format that is to be used under a given set of conditions. The client profiles may be used by the media format negotiation module 40 when communicating with the server 10. For example, one client profile may be used in a scenario where a minimum bandwidth, processing power or other quality-of-service parameters are guaranteed, whereas another client profile may be used when one or more quality-of-service parameters are not guaranteed. Instead of using client profiles, in another implementation the media format negotiation module 40 may simply maintain a list of preferred media formats ranked from most preferable to least preferable. In yet another implementation the user may be prompted to manually select a preferred media format.

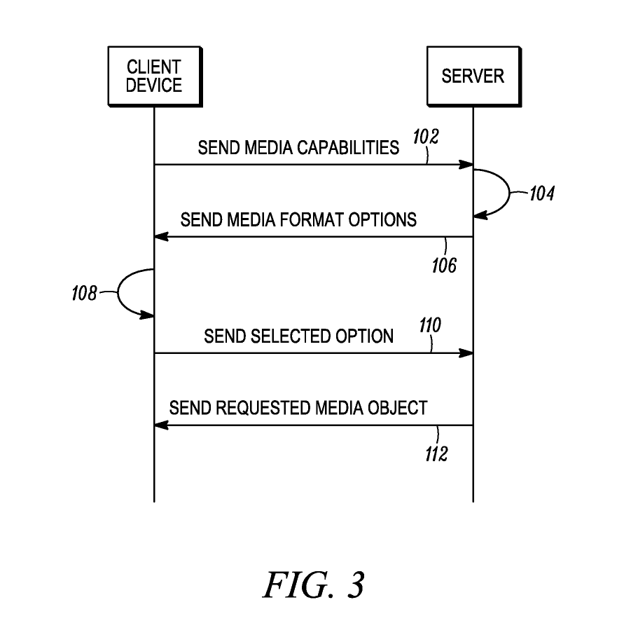

One illustrative example of a message exchange process used to negotiate a media format between a client device and server is shown in FIG. 3. It should be noted that the details of this message exchange process will depend on many factors that may differ from case to case. Accordingly, the message exchange process shown in FIG. 3 is presented for illustrative purposes only and should not be construed as limiting in any way. For example, the data included in the messages may be combined into a fewer number of messages or, in some cases, divided among a greater number of message. Moreover, the message exchange process depicted in FIG. 3 may be a part of a handshaking procedure during which the client device and server agree on various protocols and parameters used to establish a communication session between them. For instance, if the client device and the server communicate using the Hypertext Transfer Protocol (HTTP), the message exchange process of FIG. 3 may occur as part of the process used to establish a Transmission Control Protocol (TCP) connection. As another example, in some implementations a secure connection is to be established between the client device and the server. In this case the message exchange process of FIG. 3 may occur concurrently with, before or after the secure connection is being established. Such a secure connection may be established using, for instance, the Transport Layer Security (TLS) protocol in which one-way or two-way authentication is employed.

Referring now to FIG. 3, the client device communicates it media capabilities to the server at 102. In this example the client device has already requested a particular media object, either prior to or during the message exchange process depicted in FIG. 3. At a minimum these capabilities specify the media format or formats that the client device supports. Upon receiving the client device's media capabilities, at 104 the server compares them to the media formats in which it is able to provide the requested media object. These media formats may include media formats in which the media objects are maintained by the server and/or media formats into which the media objects can be transcoded by the server in real-time or near real-time. Upon finding the media format or formats that best match the client device's media capabilities, the server sends media format options to the client device at 106. At 108 the client device selects the most suitable option, which, if one or more client profiles are employed, may vary depending upon the circumstances such as bandwidth and processor availability. The client device sends a message to the server at 110 communicating its selected media format. Finally, at 112 the server sends the requested media object to the client device in the desired media format.

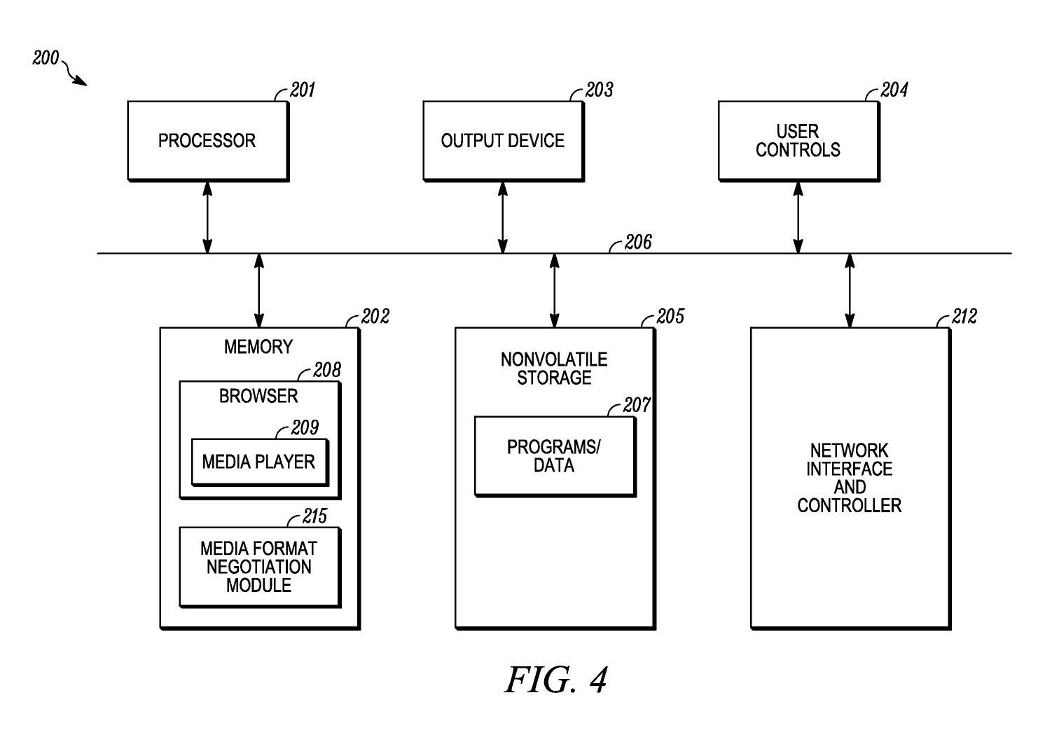

FIG. 4 depicts one example of an architecture 200 that may be employed by the client device shown in FIGS. 1 and 2. The architecture 200 includes: at least one processor 201; memory 202, which may include read only memory (ROM), random access memory (RAM), cache memory, graphics card memory and the like; at least one output device 203 such as a display and/or a speaker for presenting media objects rendered by a media player; user controls 204, such as a keyboard and a mouse, trackball or similar device; and nonvolatile storage 205, such as a magnetic or optical disk drive (either local or on a remote network node); and network interface and controller 212. Network interface and controller 212 provides a connection to the communications network to receive the media content from the server media. Network interface and controller 212 may take the form of a conventional modem adapted for connection to a phone line in a public switch telephone network or a broadband modem for connection to a broadband network such as a cable or DSL network.

Processor 201, memory 202, display 203, user controls 204, network interface and controller 212 and nonvolatile storage 205 are all coupled by an interconnect 206, such as one or more buses and/or a network connection, and are interoperable. The client device architecture 200 is constructed and operates according to known techniques, including a basic input/output system (BIOS), and operating system (OS), and one or more applications or user programs.

Those skilled in the art will recognize that, for simplicity and clarity, the full structure and operation of the client device is not being depicted or described herein. Instead, only so much of the client device is described as needed to facilitate an understanding of the systems and method being depicted and described herein. The remainder of the construction and operation of the client device may conform to any of the various implementations and practices known in the art.

Nonvolatile storage 205 conventionally contains a variety of user programs and user data 207, where the user programs are loaded into memory 202 for execution and may be employed in customizing the operation of such user programs. In the context of the present disclosure, programs 207 loaded into memory 202 include a browser 208 or similar application within which a media player 209 operates as a plug-in as well as a media format negotiation module or component 215.

Any of the disclosed methods can be implemented as computer-executable instructions stored on one or more computer-readable storage media (e.g., non-transitory computer-readable media, such as one or more volatile memory components (such as DRAM or SRAM), or nonvolatile memory components (such as hard drives) and executed on a processor. Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, by a processor on a single local computer (e.g., any suitable commercially available computer) or in a network environment (e.g., via the Internet, a wide-area network, a local-area network, a client-server network (such as a cloud computing network or other such network) using one or more network computers.

1. A method of negotiating a media format to be used by a client device to access a media object, comprising:
receiving data over a communications network from a client device, the data specifying at least one media format in which the client device is able to render the media object;
based on the data received from the client device, determining one or more media formats in which the media object is available such that the media object is renderable by the client device; and
delivering the media object to the client device over the communications network in at least one of the one or more media formats.

2. The method of claim 1 wherein the at least one media format specified by the client device includes at least one codec available to the client device.

3. The method of claim 1 further comprising receiving a device description document that presents the data in a structured data format.

4. The method of claim 3 wherein the structured data format is XML.

5. The method of claim 1 wherein the data further specifies at least one device-specific media capability of the client device.

6. The method of claim 1 further comprising sending to the client device over the communication network one or more media format options in which the media object is available.

7. The method of claim 6 in which the one or more media format options are included in a media format description document that presents the media format options to the client device in a structured data format.

8. The method of claim 1 further comprising receiving from the client device over the communications network a selected media format in which the media object is to be delivered, wherein delivering the media object to the client device includes delivering the media object to the client device in the selected media format.

9. The method of claim 1 further comprising transcoding the media object into one of the media formats in which the client device is able to render the media object

10. A computer-readable storage medium containing instructions which, when executed by one or more processors, implements a method of negotiating a media format to be used by a client device to access a media object, comprising:
sending from a client device to a media content source over a communications network data specifying at least one media format supported by the client device; and
receiving from the media content source over the communications network a media object in one of the media formats supported by client device.

11. The computer-readable storage medium of claim 10 wherein the media content source is a web server.

12. The computer-readable storage medium of claim 10 wherein sending the data specifying the at least one media format includes sending the data specifying the at least one media format along with a request to receive the media object.

13. The computer-readable storage medium of claim 10 further comprising:
receiving from the media content source a plurality of options each specifying a different media format supported by the client device;
selecting one of the media format options such that the selected media format is supported by the client device; and
communicating the selected option to the source of media content over the communications network, wherein receiving the media object includes receiving the media object in the selected media format.

14. The computer-readable storage medium of claim 13 wherein selecting one of the media format options includes comparing the plurality of options to a client profile that specifies a plurality of media formats supported by the client device, each of the plurality of media formats being selected under a different specified set of conditions.

15. A client device, comprising:
a network interface for communicating over a communications network;
at least one media player for rendering media objects received by the network interface over the communications network;
at least one output device for presenting the media object rendered by the media player; and
a processor configured to send one or more parameters reflecting a media format that is supported by the media player to a media content source over the communications network.

16. The client device of claim 15 wherein the one or more parameters includes at least one additional parameter specifying at least one media capability of the output device.

17. The client device of claim 15 wherein the processor is further configured to (i) select a media format from among a plurality of media format options provided by the media content source in response to receipt of the one or more parameters and (ii) communicate the selection to the media content source.

18. The client device of claim 15 wherein the one or more parameters is sent to the media content source in a device description document that presents the one or more parameters in a structured data format.

19. The client device of claim 18 wherein the structured data format is XML.

20. The client device of claims 17 wherein the processor is further configured to compare the plurality of media format options to a client profile that specifies a plurality of media formats supported by the client device, each of the plurality of media formats being selected under a different set of conditions specified by the client profile.
